(19) United States
(12) Patent Application Publication
(10) Pub. No.: US 2023/0269386 A1
(43) Pub. Date: Aug. 24, 2023

(54) OPTIMIZED FAST MULTIPASS VIDEO TRANSCODING

(71) Applicant: BITMOVIN, INC., San Francisco, CA (US)

(72) Inventors: Adithyan Ilangovan, Klagenfurt am Wörthersee (AT); Gerald Götzenbrucker, Villach (AT); Riccardo Ressi, Klagenfurt am Wörthersee (AT)

(73) Assignee: BITMOVIN, INC., San Francisco, CA (US)

(21) Appl. No.: 18/016,577

(22) PCT Filed: May 27, 2021
(86) PCT No.: PCT/US21/34504

§ 371 Date: Jan. 17, 2023

Related U.S. Application Data
(60) Provisional application No. 63/057,119, filed on Jul. 27, 2020.

(51) Int. Cl. H04N 19/40; H04N 19/12; H04N 21/2343

(52) U.S. Cl. CPC H04N 19/40; H04N 19/12; H04N 21/234309

(57) ABSTRACT

A computer-implemented method and system for transcoding input video content is provided. The method includes decoding the input video content from a first format to a first set of raw video data. Encoding the first set of raw video data into an intermediate format and storing the video data in the second intermediate format. Also encoding the first set of raw video data into a third desired output format to extract video parameters and determining optimized encoding parameters for encoding the video content into the final output video. The method includes decoding the stored video data encoded into the intermediate format into a second set of raw video data and encoding the second set of raw video data into the third desired output format using the optimized encoding parameters to generate the final output video.

### CROSS-REFERENCE TO RELATED APPLICATIONS

This application claims priority to U.S. Provisional Patent Application No. 63/057,119 entitled “Optimized Fast Multipass Video Transcoding,” filed Jul. 27, 2020, the contents of which are hereby incorporated by reference in their entirety.

### BACKGROUND

This disclosure generally relates to transcoding of video or other media, and more particularly to the decoding phase of multipass transcoding of video titles using an optimized multi-pass approach.

Due to the increasing availability of mobile high-speed Internet connections like WLAN/3G/4G/5G and the huge smartphone and tablet device boom in the recent years, mobile video streaming has become an important aspect of modern life. Online video portals like YouTube or Netflix deploy progressive download or adaptive video on demand systems and count millions of users watching their content every day. Real-time entertainment produces nearly 50% of the U.S. peak traffic nowadays. This volume is expected to increase as the distribution of content world-wide moves to streaming platforms and stream size increases with additional audio-visual quality features, e.g., HDR, Atmos, etc., and with higher and higher resolutions, transitioning from 1080p to 4K, 8K, and future developed resolution standards. Moreover, particularly for mobile environments, adaptive streaming is required to cope with the considerable high fluctuations in available bandwidth. The video stream has to adapt to the varying bandwidth capabilities in order to deliver the user a continuous video stream without stalls at the best possible quality for the moment, which is achieved, for example, by dynamic adaptive streaming over HTTP.

In this context, adaptive streaming technologies, such as the ISO/IEC MPEG standard Dynamic Adaptive Streaming over HTTP (DASH), Microsoft's Smooth Streaming, Adobe's HTTP Dynamic Streaming, and Apple Inc.'s HTTP Live Streaming, have received a lot of attention in the past few years. These streaming technologies require the generation of content of multiple encoding bitrates and varying quality to enable the dynamic switching between different versions of a title with different bandwidth requirements to adapt to changing conditions in the network. Hence, it is important to provide easy content generation tools to developers to enable the user to encode and multiplex content in segmented and continuous file structures of differing qualities with the associated manifest files.

Existing encoder approaches allow users to quickly and efficiently generate content at multiple quality levels suitable for adapting streaming approaches. For example, a content generation tool for DASH video on demand content has been developed by Bitmovin, Inc. (San Francisco, Calif.), and it allows users to generate content for a given video title without the need to encode and multiplex each quality level of the final DASH content separately. The encoder generates the desired representations (quality/bitrate levels), such as in fragmented MP4 files, and MPD file, based on a given configuration, such as for example via a RESTful API. Given the set of parameters the user has a wide range of possibilities for the content generation, including the variation of the segment size, bitrate, resolution, encoding settings, URL, etc. Using batch processing, multiple encodings can be automatically performed to produce a final DASH source fully automatically.

The overall process, referred to as transcoding, converts the original encoding format of the media to the final desired encoding format. In some instances, before a video can be encoded into the final desired format, the source video material needs to be decoded from a different original format. For example, some high-definition video files are delivered from the editors using ProRes as a video format. But ProRes is not intended for streaming or other end-user viewing. Thus, decoding ProRes encoded content and encoding into an end-user viewing format is typically done. Further, to improve the quality and efficiency of the encoding process, in some instances a two-pass encoding approach can be used. In a first pass, an in-depth analysis of the entire video is performed before the encoding is started, to for example determine a “complexity bucket” into which the video would be categorized. Once a complexity is determined for the video, the video is then encoded according to the settings that have been determined to be optimal for that type of complexity. When the video file is encoded, a target bitrate and associated encoder settings is used throughout the file to encode the video.

For example, FIG. 1 provides an illustration of a conventional two-pass transcoding process. First, the source video material 110 is decoded 112a and the decoded frames 113 are then encoded 114a into the desired format a first time, first pass 101, to analyze the source content and determine the complexity of the video and the parameter statistics 115 to be used for the final encoding process. Then, in the second pass 102, the source video 110 is decoded 112b a second time and the decoded frames 113b are encoded 114b again into the final form using the complexity and statistics 115 derived from the first pass to produce a better encoded output video 118. As illustrated in FIG. 2, the decoding process 112a/b is usually computationally less complex than the encoding process 112a/b for both the first pass and the second pass. FIG. 2 illustrates computational complexity as relative time spent in the encoding and decoding processes.

However, there are some instances in which the decoding of video content can be significantly more complex. Some video codecs do not scale very well or perform well for real-time applications. For example, when an input video is encoded in ProRes or the JPEG-2000 format, decoding these formats in a transcoding process is complex and computationally expensive. This higher decoding complexity significantly impacts the complexity of the entire transcoding process, requiring an increase in transcoding costs and/or more time to perform transcoding. For example, the computational complexity of the overall transcoding process can be increased by multiple times given the need to decode the original content more than once.

Thus, what is needed is an efficient decoding approach for a multi-pass transcoding process with complex decoding requirements that provides an optimized overall transcoding for a given video content with improved performance.

### SUMMARY

According to embodiments of the disclosure, a computer-implemented method and system for transcoding input video content is provided. The method includes decoding the input video content from a first format to a first set of raw video data. Encoding the first set of raw video data into an intermediate format and storing the video data in the second intermediate format. Also encoding the first set of raw video data into a third desired output format to extract video parameters and determining optimized encoding parameters for encoding the video content into the final output video. The method then includes decoding the stored video data encoded into the intermediate format into a second set of raw video data and encoding the second set of raw video data into the third desired output format using the optimized encoding parameters to generate the final output video.

According to one embodiment, a computer-implemented method for transcoding an input video from a first format to an output video in a desired format is provided. The method includes decoding the input video from the first format into a first set of video data frames. The first set of video data frames are then encoded into an intermediate video based on a second video format. The first set of video data frames are also encoded into a temporary output video based on the desired format. The method also includes analyzing the temporary output video to extract encoding statistics. The encoding statistics are used for determining optimized encoding parameters for encoding a second set of video data frames into the output video. The method also includes decoding the intermediate video into a second set of video data frames and then encoding the second set of video data frames into the output video based on the desired format and the optimized encoding parameters.

According to embodiments, the analyzing of the temporary output video may include obtaining metrics for the temporary output video. In these embodiments, the determining optimized encoding parameters is based on the metrics for the temporary output video.

In some embodiments the first format may be ProRes or JPEG 2000, the second video format may be a substantially lossless video encoding format, for example, H.264, H.265, HEVC, FFV1, VP9, MPEG-2 and the desired format may be one of H.264, H.265, HEVC, FFV1, VP9, MPEG-2, or a later developed video format.

In some embodiments the method may also include storing the output video in a network-accessible storage for streaming

Other embodiments provide for non-transitory computer-readable medium storing computer instructions for transcoding an input video from a first format to an output video in a desired format that when executed on one or more computer processors perform the steps of the method.

Yet other embodiments provide a computer-implemented system for transcoding an input video from a first format to an output video in a desired format comprising means for performing each of the method steps. Such systems may be provided as a cloud-based encoding service in some embodiments.

### BRIEF DESCRIPTION OF THE DRAWINGS

FIG. 1 is an illustrative diagram of a conventional two-pass transcoding process.

FIG. 2 is a diagram illustrating the relative computational complexity of decoding and encoding of a typical input in a conventional two-pass transcoding process.

FIG. 3 is a diagram illustrating a transcoding system according to one embodiment.

FIG. 4 is a flow chart illustrative of a method for transcoding video content according to one embodiment.

FIG. 5 is an illustrative diagram of a two-pass transcoding process according to one embodiment.

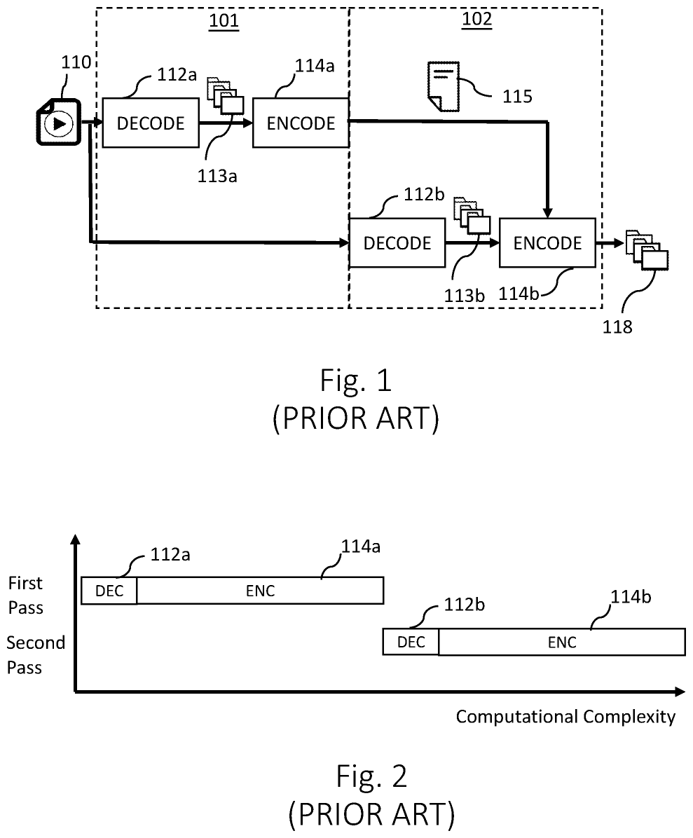

The figures depict various example embodiments of the present disclosure for purposes of illustration only. One of ordinary skill in the art will readily recognize from the following discussion that other example embodiments based on alternative structures and methods may be implemented without departing from the principles of this disclosure and which are encompassed within the scope of this disclosure.

### DESCRIPTION OF EMBODIMENTS OF THE INVENTION

The following description describes certain embodiments by way of illustration only. One of ordinary skill in the art will readily recognize from the following description that alternative embodiments of the structures and methods illustrated herein may be employed without departing from the principles described herein. Reference will now be made in detail to several embodiments.

The above and other needs are met by the disclosed methods, a non-transitory computer-readable storage medium storing executable code, and systems for transcoding video content.

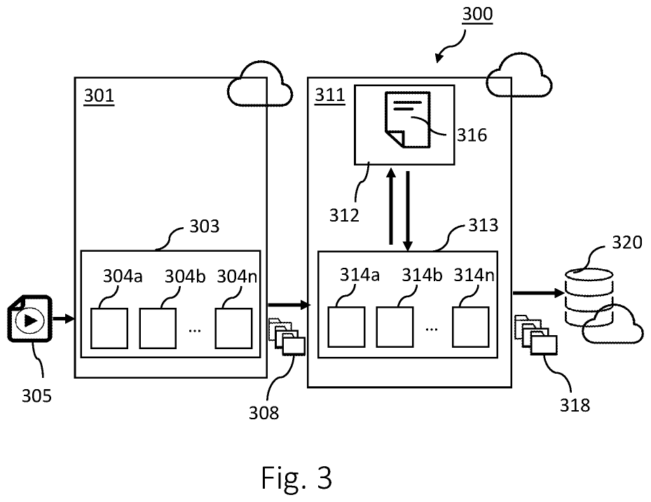

Now referring to FIG. 3, an content transcoding system is illustrated according to embodiments of the invention. A transcoding system as described herein includes the hardware and software for decoding the input video from a first format into a first set of video data frames, for encoding the first set of video data frames into an intermediate video based on a second video format, for encoding the first set of video data frames into a temporary output video based on the desired format, for analyzing the temporary output video to extract encoding statistics, for determining optimized encoding parameters for encoding a second set of video data frames into the output video based on the extracted encoding statistics, for decoding the intermediate video into a second set of video data frames, and for encoding the second set of video data frames into the output video based on the desired format and the optimized encoding parameters.

For example, in one embodiment, the transcoding system 300 is a cloud-based encoding system available via computer networks, such as the Internet, a virtual private network, or the like. The transcoding system 300 and any of its components may be hosted by a third party or kept within the premises of an encoding enterprise, such as a publisher, video streaming service, or the like. The transcoding system 300 may be a distributed system but may also be implemented in a single server system, multi-core server system, virtual server system, multi-blade system, data center, or the like. The transcoding system 300 and its components may be implemented in hardware and software in any desired combination within the scope of the various embodiments described herein.

According to one embodiment, the transcoding system 300 includes a decoder server 301 for decoding input video from any format into a first set of video data frames. The decoder server 301 includes a decoder modules 303. The decoder module 303 may include any number of decoding submodules 304a, 304b, . . . , 304n, each capable of decoding an input video 305 provided in a specific format. For example, decoding submodule 304a may be an JPEG-2000 decoding submodule for decoding an input video 305 into a set of decoded media frames 308 according to the JPEG-2000 standard, for example using algorithms in a JPEG-2000 codec, such as J2K, OpenJPEG, or the like. Other decoding submodules 304b-304n may provide decoding of video for other formats. In addition, decoding submodules 304b-304n may use algorithms from any type of codec for video decoding, including, for example, ProRes 422, ProRes 4444, x264, x265, libvpx, and any other codecs for H.264/AVC, H.265/HEVC, VP8, VP9, AV1, or others. Any decoding standard or protocol may be supported by the decoder module 303 by providing a suitable decoding submodule with the software and/or hardware required to implement the desired decoding.

According to another aspect of various embodiments, the decoder server 301 may include multiple servers and/or multiple instances of a decoder server 301 running in a server farm. While in some embodiments the input video 305 may be processed linearly, from beginning to end of the input video, in other embodiments the input video may be subdivided into sections or chunks which are then processed in parallel, thereby speeding the decoding process. For example, to speed up the decoding process, an input video 305 may be divided in several sections or chunks and each chunk can be processed in parallel by one server 301 or instance of server 301. Alternatively, a single server 301 may execute multiple instances of a given decoding submodule 304n to process the sections or chunks of the input video 305 in parallel. The input video 305 may be an source video or may be any video that is undergoing transcoding by the system, for example, an intermediate video encoded according to a fast decode format. Once processed, the input video 305 is decoded into a set of video data 308, such as for example, a set of video frames 308. The decoded video data 308 may be transferred to other components of the transcoding system for further processing, for example as data in a data bus or through any data communication methods.

According to one embodiment, the transcoding system 300 also includes an encoder server 311 for encoding video data frames into encoded video based on any video format and for analyzing video to extract statistics and determine optimized encoding parameters. For this purpose, in embodiments, the encoder server 311 includes a statistics generation module 312 and an encoder module 313. The encoding module 313 may include any number of encoding submodules 314a, 314b, . . . , 314n, each capable of encoding input video frames 308 into a specific encoding format. For example, encoding submodule 314a may be an MPEG-DASH encoding submodule for encoding input video 308 into a set of encoded media 318 according to the ISO/IEC MPEG standard for Dynamic Adaptive Streaming over HTTP (DASH). The encoded media 318 may be the final output video encoded according to a desired format, may be intermediate video generated as part of the transcoding process, or may be temporary output video used to extract statistics and determine optimized encoding parameters for subsequent encoding passes. Any number of encoding submodules 314b-314n may be provided to enable encoding of video for any number of formats, including without limitation Microsoft's Smooth Streaming, Adobe's HTTP Dynamic Streaming, and Apple Inc.'s HTTP Live Streaming In addition, encoding submodules 314b-314n may use algorithms from any type of codec for video encoding, including, for example, H.264/AVC, H.265/HEVC, VP8, VP9, AV1, and others. Any encoding standard or protocol may be supported by the encoder module 313 by providing a suitable encoding submodule with the software and/or hardware required to implement the desired encoding, based for example on algorithms from video codecs, such as AV1, x264, x265, FFmpeg, FFays, OpenH264, DivX, VP3, VP4, VP5, VP6, VP7, libvpx, MainConcept, or similar codecs.

According to one aspect of embodiments of the invention, the encoder module 313 encodes input video frames 308 at multiple bitrates with varying resolutions into a resulting encoded media 318. For example, in one embodiment, the encoded media 318 includes a set of fragmented MP4 files encoded according to the H.264 video encoding standard and a media presentation description (“MPD”) file according to the MPEG-DASH specification. In an alternative embodiment, the encoding module 313 encodes a single input video 308 into multiple sets of encoded media 318 according to multiple encoding formats, such as MPEG-DASH and HLS for example. The encoder 313 is capable of generating output encoded in any number of formats as supported by its sub-encoding modules 314a-n. The input video frames 308 may be a source video or may be any video frames undergoing transcoding by the system, for example, an output of an intermediate video decoded according to a fast decode format.

According to another aspect of various embodiments, the encoder module 313 encodes the input video frames 308 based on a given configuration 316. The configuration 316 can be received into the encoding server 311, via files, command line parameters provided by a user, via API calls, HTML commands, or the like. The configuration 316 includes parameters for controlling the content generation, including the variation of the segment sizes, bitrates, resolutions, encoding settings, URL, etc. According to another aspect of various embodiments, the configuration 316 may be customized for the input video 305 to provide an optimal encoding parameters for encoding the final output video 318. The optimal encoding parameters may be provided based on the statics module 312, which extracts and analyzes the encoded data to derive statistics and other metrics to optimize the encoding parameters in the customized input configuration 316. The customized input configuration 316 can be used to control the encoding processes in encoder module 313. For example, in one embodiment a statistics module 312 may provide a customized bitrate ladder as further described in U.S. patent application Ser. No. 16/167,464, filed on Oct. 22, 2018 by the applicant of this application, which is incorporated herein by reference.

While FIG. 3 illustrates the decoder server 301 and encoder server 311 as separate servers, different embodiments may arrange the decoder and encoder processes in different configurations. For example, the server 301 and server 311 may be the same server, instances of virtual servers, or the like. For example, in one embodiment, the decoding and encoding functionalities of server 301 and server 311 are provided in a single transcoding server that decodes and encodes data, for example, using a pipeline approach.

According to another aspect of various embodiments, the encoded output 318 is then delivered to storage 320. For example, in one embodiment, storage 320 includes a content delivery network (“CDN”) for making the encoded content 318 available via a network, such as the Internet. The delivery process may include a publication or release procedure, for example, allowing a publisher to check the quality of the encoded content 318 before making it available to the public. In another embodiment, the encoded output 318 may be delivered to storage 320 and be immediately available for streaming or download, for example, via a website.

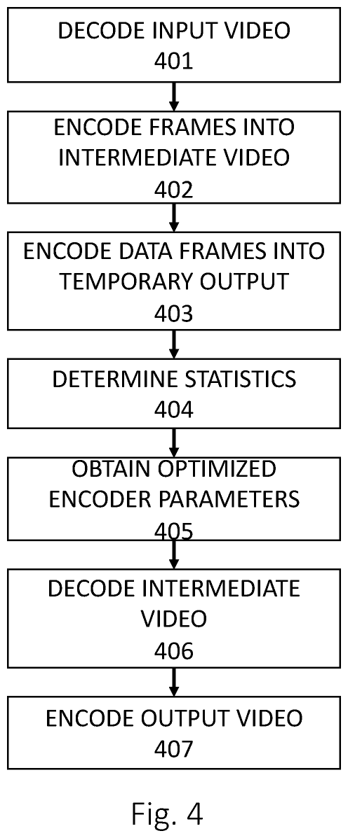

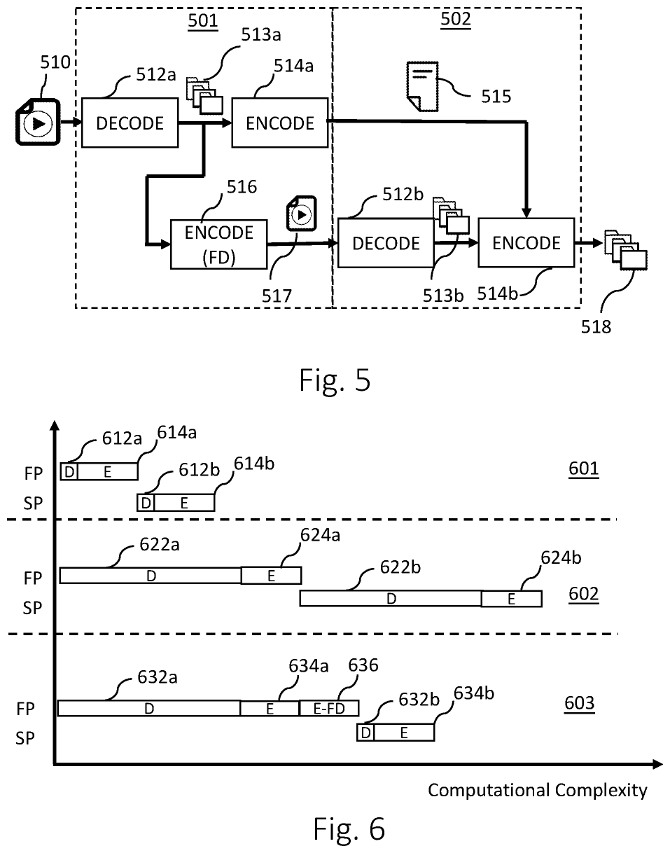

Now referring to FIG. 4, a transcoding process is provided according to various embodiments. An input video encoded according to a video format is decoded 401 into video data. For example, decoded video data may include a plurality of video frames as a bitstream, with each frame represented by its pixels in a given color space, e.g., YUV, RGB, HSL/HSV, or the like. The bitstream may also include audio data synchronized with the video frames. The decoded frames are then encoded 402 into an intermediate video format. This encoding creates a lossless (or nearly lossless) representation of the original input. For example, a “fast decode” video format can be used as the intermediate video format to speed up the transcoding process. The decoding of the lossless or near lossless “fast decode” format is simpler, less time consuming, or otherwise less computationally expensive than the decoding of the original input video format. For example, in one embodiment, the original input video is formatted as JPEG 2000 and the intermediate “fast code” format is H.264. In such an embodiment, the total decoding complexity can be reduced by up to 50%. The improved transcoding approach according to this embodiment can be applied to any source video material encoded in a “complex decode format,” that is, a format which requires more computing time to decode twice than decoding once and encoding and decoding using a “fast decode” format. For example, JPEG 2000 and ProRes are examples of complex formats when compared to the use of H.264 or H.265 as a fast decode intermediate format.

The decoded frames are also encoded 403 into a temporary output video in the desired output format. This encoding 403 and the intermediate video encoding 402 can take place in any order or take place substantially at the same time. In one embodiment, encoding 403 may be a multi-pass probe-encoding process as further described in U.S. patent application Ser. No. 16/370,068, filed on Mar. 29, 2019, titled Optimized Multipass Video Encoding, or as described in U.S. patent application Ser. No. 16/167,464, filed on Oct. 22, 2018, titled Video Encoding Based on Customized Bitrate Table, both of which are incorporated herein by reference. As described in these applications, the encoding 403 into the temporary output video allows for the determination 404 of statistics about the encoding process for the given video data. For example, as an encoder node encodes the video, a statistics file (“.stats file”) for the video is written saving the statistics for each input frame. After analyzing the video data to determine encoding statistics, a set of optimized encoder parameters is obtained 405.

In embodiments, the statistics determination 404 during the first pass provides a set of characteristics for the video to be encoded into the output video that is analyzed to determine appropriate encoder settings for the output video. The video statistics derived from the temporary output video can include any number of metrics, such as noisiness or peak signal-to-noise ratio (“PSNR”), video multimethod assessment fusion (“VMAF”) parameters, structural similarity (SSIM) index, as well as other video features, such as motion-estimation parameters, scene-change detection parameters, audio compression, number of channels, or the like. In some embodiments, the statistics metrics can include subjective quality factors, for example obtained from user feedback, reviews, studies, or the like. In embodiments, the video statistics are analyzed to obtain 405 a set of encoder settings optimized for the encoding of the output video. In embodiments, the encoder parameters that are obtained from the first pass can include quantizer step settings, target bit rates, including average rate and local maxima and minima for any chunk, target file size, motion compensation settings, maximum and minimum keyframe interval, rate-distortion optimization, psycho-visual optimization, adaptive quantization optimization, other filters to be applied, and the like.

In a subsequent pass, the intermediate video is decoded 406 from its fast decode format to a set of decoded video data, such as video frame data described above. This second-pass decode process 406 is faster and/or less computationally expensive than the decoding 401 of the original input video, for example, decoding from a “fast decode” H.264 video input instead of an original JPEG 2000, ProRes, or other complex decode format encoded video input. Then, the decoded video data is encoded 407 once again into the final output video using the optimized encoder parameters.

Now referring to FIG. 5, an illustration of a two-pass transcoding process according to embodiments of this invention is provided. First, the source video 510 is decoded 512a and the decoded frames 513a are then encoded 514a into the desired format a first time, first pass 501, to analyze the source content and determine the complexity of the video and the parameter statistics 515 to be used for the final encoding process. In this first pass 501, the decoded frames 513a are also encoded 516 into a “fast decode” format intermediate video 517. Then, in the second pass 502, the intermediate video 517 is decoded 512b in a faster/less complex decode process than the original decode 512a. The decoded frames 513b are encoded 514b again into the final form using the complexity and statistics 515 derived from the first pass to produce a better encoded output video 518.

Now referring to FIG. 6, a diagram is provided illustrating the comparative computational complexity of a two-pass transcoding process according to embodiments of the invention versus conventional approaches in the prior art. FIG. 6 illustrates computational complexity as relative time spent in the encoding and decoding processes. At the top of the diagram 601, a conventional two-pass transcode process for a typical video input is illustrated. This is similar to the diagram provided in FIG. 2. The decoding process 612a/b is usually computationally less complex than the encoding process 612a/b for both the first pass and the second pass. In the middle of the diagram 602, a situation in which the input file is in a format that requires a significantly more complex decoding 622a/b is illustrated. In this scenario, the computational complexity of the encoding 624a/b is equivalent to that of the typical case illustrated in 601.

However, given the much higher complexity decoding 622a/b, the overall computational complexity for the two-pass (FP and SP) transcoding is significantly higher, in this example approximately 3 times, than that of the typical scenario in 601. The bottom of the diagram 603 illustrates a two-pass transcoding process according to embodiments of the invention. In this scenario, the highly complex decode 632a of the input video is performed in the first pass (FP). Then, the first pass (FP) encoding process 634a is equivalent in complexity as the encoding in 602 and 601. This scenario, however, includes an additional encode 636 into a “fast decode” (E-FD) as part of the first pass (FP). For the second pass (SP), a much simpler decode 632b is used to decode the “fast decode” video instead of decoding the original input video again. This computational complexity of this decode 632b is equivalent to that of the typical scenario depicted in 601. Then a last encode 634b is performed using the output from the fast decode 632b. Accordingly, a significant complexity reduction is provided, significantly reducing the overall transcode time, in this example by about one third. While not illustrated in FIG. 6, it should be noted that the additional encode 636 may be performed substantially in parallel with the first encode 634a, thereby further reducing the time requirement for the overall transcoding process. The potential savings in decoding complexity reduction will far outweigh the additional complexity introduced by the lossless or near-lossless encoding 636 in the first pass. These savings can either reflect the cost spent in the transcoding, and/or the time spent in the transcoding process. Since the intermediate representation is substantially lossless, there would be no significant quality degradation introduced in the generated output. For example, with J2K as source input and H.264 as an intermediate input, the total decoding complexity can be reduced by approximately 50% without significant quality degradation.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability, including multi-core processors and distributed processor architectures, whether hosted in a single location or across multiple locations, such as public, hybrid, or private cloud implementations.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

What is claimed is:

1. A computer-implemented method for transcoding an input video from a first format to an output video in a desired format, the method comprising:
decoding the input video from the first format into a first set of video data frames;
encoding the first set of video data frames into an intermediate video based on a second video format;
encoding the first set of video data frames into a temporary output video based on the desired format;
analyzing the temporary output video to extract encoding statistics;
determining optimized encoding parameters for encoding a second set of video data frames into the output video based on the extracted encoding statistics;
decoding the intermediate video into a second set of video data frames;
encoding the second set of video data frames into the output video based on the desired format and the optimized encoding parameters.

2. The method of claim 1, wherein the analyzing the temporary output video comprises obtaining metrics for the temporary output video.

3. The method of claim 2, wherein the determining optimized encoding parameters is based on the metrics for the temporary output video.

4. The method of claim 1, wherein the first format is a complex decode format.

5. The method of claim 4, wherein the complex decode format is one of ProRes or JPEG 2000.

6. The method of claim 1, wherein the second video format is fast-decode format.

7. The method of claim 6, wherein the fast-decode format is a substantially lossless video encoding format.

8. The method of claim 6, wherein the second video format is one of H.264, H.265, HEVC, FFV1, VP9, MPEG-2.

9. The method of claim 1, wherein the desired format is one of H.265, AV1, HEVC, FFV1, VP9, MPEG-2, or a later developed video format.

10. The method of claim 1, further comprising storing the output video in a network-accessible storage for streaming.

11. A non-transitory computer-readable medium storing computer instructions for transcoding an input video from a first format to an output video in a desired format that when executed on one or more computer processors perform the steps of:
decoding the input video from the first format into a first set of video data frames;
encoding the first set of video data frames into an intermediate video based on a second video format;
encoding the first set of video data frames into a temporary output video based on the desired format;
analyzing the temporary output video to extract encoding statistics;
determining optimized encoding parameters for encoding a second set of video data frames into the output video based on the extracted encoding statistics;
decoding the intermediate video into a second set of video data frames;
encoding the second set of video data frames into the output video based on the desired format and the optimized encoding parameters.

12. The non-transitory computer-readable medium of claim 11, wherein the computer instructions for transcoding an input video from a first format to an output video in a desired format that when executed on one or more computer processors performs the step of analyzing the temporary output video to extract encoding statistics further obtains metrics for the temporary output video.

13. The non-transitory computer-readable medium of claim 12, wherein the determining optimized encoding parameters is based on the metrics for the temporary output video.

14. The non-transitory computer-readable medium of claim 12, wherein the first format is JPEG 2000.

15. The non-transitory computer-readable medium of claim 12, wherein the second video format is a substantially lossless video encoding format.

16. The non-transitory computer-readable medium of claim 15, wherein the second video format is one of H.264, H.265, HEVC, FFV1, VP9, or MPEG-2.

17. The non-transitory computer-readable medium of claim 12, wherein the desired format is one of H.265, AV1, HEVC, VP9, FFV1, MPEG-2, or a later developed video format.

18. The non-transitory computer-readable medium of claim 12, wherein the computer instructions for transcoding an input video from a first format to an output video in a desired format that when executed on one or more computer processors further perform the step of storing the output video in a network-accessible storage for streaming.

19. A computer-implemented system for transcoding an input video from a first format to an output video in a desired format, the system comprising:
means for decoding the input video from the first format into a first set of video data frames;
means for encoding the first set of video data frames into an intermediate video based on a second video format;
means for encoding the first set of video data frames into a temporary output video based on the desired format;
means for analyzing the temporary output video to extract encoding statistics;
means for determining optimized encoding parameters for encoding a second set of video data frames into the output video based on the extracted encoding statistics;
means for decoding the intermediate video into a second set of video data frames;
means for encoding the second set of video data frames into the output video based on the desired format and the optimized encoding parameters.

20. The system of claim 19, where the means for analyzing the temporary output video to extract encoding statistics further comprises means for obtaining metrics for the temporary output video.

21. The system of claim 19, wherein means elements are provided in a cloud-based encoding service.
